(19) United States
(12) Patent Application Publication
(10) Pub. No.: US 2026/0208509 A1
(43) Pub. Date: Jul. 23, 2026

(54) PRINTING DEVICE AND CONTROLLING METHOD THEREOF

(71) Applicant: CANON KABUSHIKI KAISHA, Tokyo (JP)

(72) Inventor: YUYA TSUCHIOKA, Kanagawa (JP)

(21) Appl. No.: 19/455,028

(22) Filed: Jan. 21, 2026

(30) Foreign Application Priority Data
Jan. 22, 2025 (JP) 2025-009187

(51) Int. Cl. B41J 11/00; B41J 3/44

(52) U.S. Cl. CPC B41J 11/0095; B41J 3/44; B41J 11/009

(57) ABSTRACT

A printing device includes a conveyance unit that conveys a recording medium along a conveyance path, a first measurement unit provided on the conveyance path that measures a conveyance amount of the recording medium based on reflected light from the recording medium, a second measurement unit that measures the conveyance amount of the recording medium based on an amount of driving of the conveyance unit, a recording unit that records an image on the recording medium, and a control unit that controls recording performed by the recording unit based on a measurement result of the first measurement unit if the recording medium is a first type and controls recording performed by the recording unit based on a measurement result of the second measurement unit if the recording medium is a second type.

### BACKGROUND

### Field of the Technology

The present disclosure relates to a printing device and a controlling method thereof.

### Description of the Related Art

Among printing devices such as a printer that conveys a loaded recording medium to perform printing, a printing device having a function of measuring an amount of conveyance (hereinafter referred to as conveyance amount) of the recording medium by a sensor is known.

Japanese Patent Laid-Open No. 2013-075489 discloses a technique for measuring a conveyance amount using a sensor in a printing device in which roll paper is loaded as a recording medium. This printing device uses an encoder sensor and an optical sensor to measure the conveyance amount of the roll paper and correct a measurement value.

As discussed in Japanese Patent Laid-Open No. 2013-075489, an optical sensor that measures optical characteristics of a recording medium or an encoder sensor that measures the amount of driving of a conveyance mechanism can be adopted as the conveyance amount sensor. In general, the optical sensor is considered to have higher accuracy. The optical sensor emits light such as an infrared radiation and receives and analyzes the light reflected on the surface of the recording medium to calculate the conveyance amount. In a case where the recording medium is special paper, such as a film sheet, light may be transmitted where the measurement accuracy of the conveyance amount will be reduced. Therefore, it is desirable to perform measurement using a conveyance amount sensor with high accuracy depending on the type of the recording medium.

Since there is a possibility that various types of recording media are loaded on the printing device, there is a need to accurately measure the conveyance amount based on the type of the recording medium.

### SUMMARY

An aspect of the present disclosure is directed to accurately measure a conveyance amount based on a type of a recording medium in a printing device.

The present disclosure provides a printing device comprising a conveyance unit that conveys a recording medium along a conveyance path, a first measurement unit provided on the conveyance path that measures a conveyance amount of the recording medium based on light reflected from the recording medium, a second measurement unit that measures the conveyance amount of the recording medium based on an amount of driving of the conveyance unit, a recording unit that records an image on the recording medium, and a control unit that performs control of recording performed by the recording unit based on a measurement result of the first measurement unit in a case where the recording medium is a first type and performs control of recording performed by the recording unit based on a measurement result of the second measurement unit in a case where the recording medium is a second type, where the second type is different from the first type.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a configuration of a printing device.

FIG. 2A is a perspective view illustrating an overall configuration of the printing device.

FIG. 2B is a perspective view illustrating an internal structure of the printing device with an upper cover opened.

FIG. 2C is a perspective view illustrating a configuration of a sensor of the printing device.

FIG. 3 is a schematic diagram illustrating a cross section of a configuration for conveying a recording medium.

FIG. 4 is a flowchart illustrating processing at the time of measuring a conveyance amount.

FIG. 5 is a flowchart illustrating processing at the time of measuring a conveyance amount according to an Example 1.

FIG. 6 is a flowchart illustrating processing at the time of measuring a conveyance amount according to an Example 2.

FIG. 7 is a flowchart illustrating processing at the time of measuring a conveyance amount when band adjustment is performed.

FIG. 8 is an example of a user interface (UI) display screen.

### DESCRIPTION OF THE EMBODIMENTS

Hereinafter, various exemplary embodiments, features, and aspects of the present disclosure will be described with reference to the drawings. The components, the control method, the dimensions, materials, and shapes of the components, the arrangement of the components, and the like described in the present disclosure may be appropriately changed according to the configuration of the device to which the disclosure is applied and various conditions. That is, the scope of the present disclosure is not limited to the following embodiment(s).

In the following description, the recording medium loaded in the printing device is typically roll paper obtained by winding a sheet of paper into a roll shape. This is not seen to be limiting, and a recording medium such as a pre-cut sheet, is applicable. The type of paper is not seen to be limiting. A material other than paper, such as a film, may be used as the material of the recording medium.

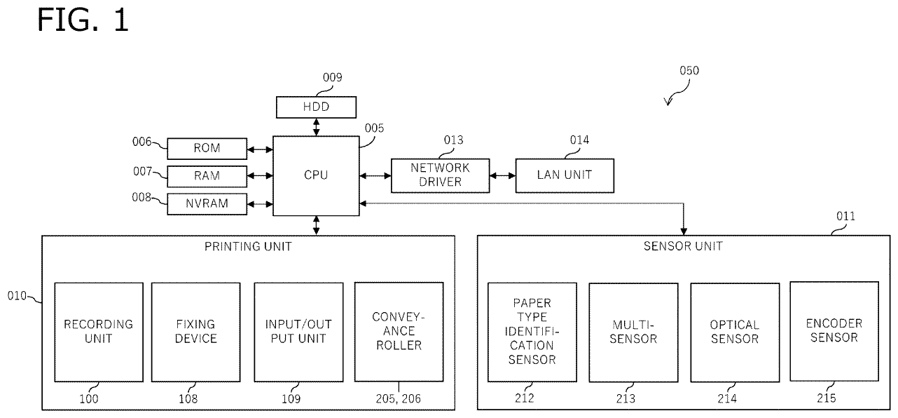

FIG. 1 is a block diagram illustrating a configuration of a printing device 050 according to an embodiment of the present disclosure. The printing device 050 includes a central processing unit (CPU) 005 that controls the printing device 050, a printing unit 010 that performs printing, and a sensor unit 011.

The printing unit 010 includes a recording unit 100, a fixing device 108, an input/output unit 109, and conveyance rollers 205 and 206. The recording unit 100 performs printing on a recording medium. The fixing device 108 dries the ink on the recording medium on which printing has been performed. The input/output unit 109 includes user interfaces such as a liquid crystal display (LCD), a light-emitting diode (LED), a key, and/or a touch panel, receives an input such as an operation or an instruction of the user, and displays information to the user. The input/output unit 109 can be considered as a set of separate units including an input unit that receives an input from the user and an output unit that outputs information to the user. The conveyance rollers 205 and 206 are conveyance units that convey the recording medium in a conveyance direction F from a loading unit to a discharge unit via the recording unit along a conveyance path P.

The sensor unit 011 includes a paper type identification sensor 212 (identification unit), a multi-sensor 213, an optical sensor 214 (first measurement unit), and an encoder sensor 215 (second measurement unit). The paper type identification sensor 212 identifies the paper type from at least one of the surface characteristics or the basis weight of the paper. As the paper type identification sensor 212, for example, a sensor in which an ultrasonic sensor and a contact image sensor (CIS) are combined can be used. In this case, the paper type identification sensor 212 estimates the paper type from the basis weight of the paper detected by the ultrasonic sensor and from the surface information of the paper detected by the CIS. The multi-sensor 213 estimates the paper type from the thickness of the paper and/or the illuminance of the reflected light. The optical sensor 214 measures the conveyance amount of the paper (first measurement value) from a change in the surface characteristics of the paper. The encoder sensor 215 measures the conveyance amount of the paper (second measurement value) from the rotation speed of the conveyance roller 205.

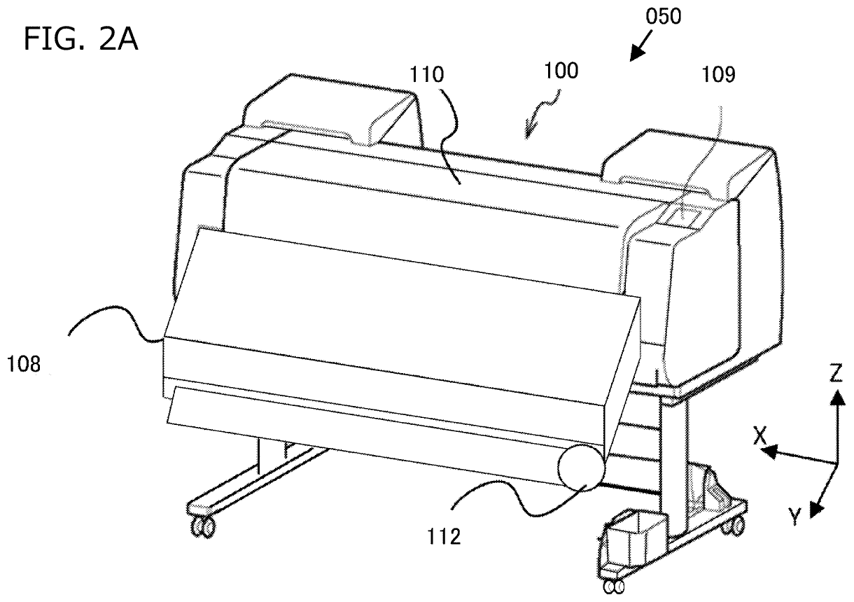

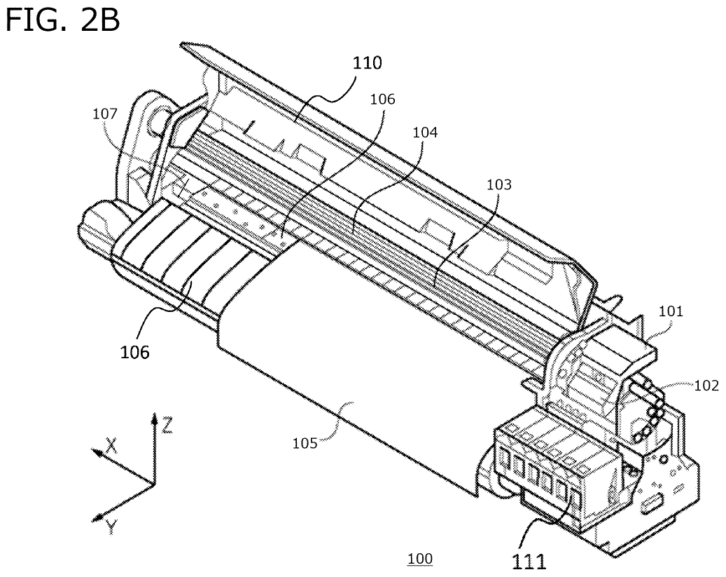

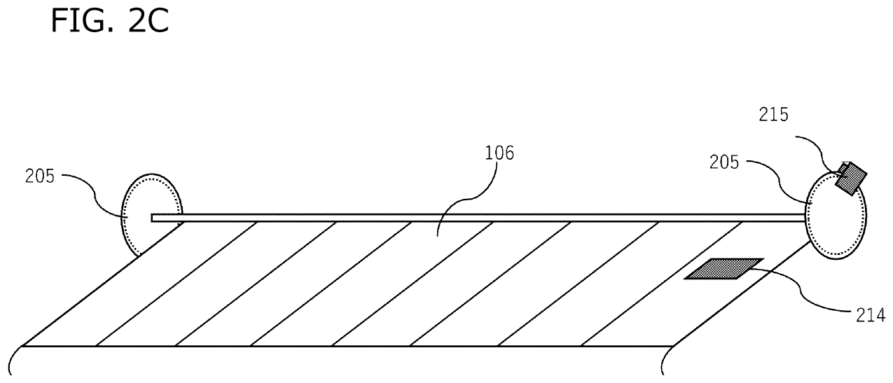

As illustrated in FIG. 2C, the optical sensor 214 is disposed on a platen 106, and the encoder sensor 215 is disposed to sandwich the conveyance roller 205.

The printing device 050 includes a read-only memory (ROM) 006, a random-access memory (RAM) 007, a nonvolatile random-access memory (NVRAM) 008, a hard disk drive (HDD) 009, a network driver 013, and a local area network (LAN) unit 014, as control components that operate in association with the CPU 005. These control components function as a control unit. The ROM 006 stores a control execution code (program) of the printing device 050. The RAM 007 stores print image data as temporary storage data when control is performed by the printing device 050. The NVRAM 008 is a nonvolatile memory, and stores a record of various data used for maintenance of the printing device 050 and information regarding an image to be printed. The HDD 009 stores image data to be printed by the printing unit 010.

The network driver 013 and the LAN unit 014 configure an interface for connecting the printing device 050 to an external connection device such as a server. The printing device 050 exchanges execution commands and data with an external connection device via the network driver 013 and the LAN unit 014. For example, image data used for printing by the printing unit 010 is transferred from an external connection device via the network driver 013 and the LAN unit 014.

FIG. 2A is a perspective view illustrating an appearance of the printing device 050, and in particular, the recording unit 100. FIG. 2B is a perspective view illustrating a state where an upper cover 110 of the recording unit 100 is opened to expose the internal structure of the printing device 050 visible. FIG. 2C is an enlarged perspective view of a vicinity of the platen 106 of the recording unit 100 for explaining a portion related to the structure of the sensor.

The recording unit 100 of the embodiment is an inkjet recording type recording device that performs recording by applying ink droplets onto a recording medium. The recording medium is conveyed along the Y-axis direction as the conveyance direction. The recording unit 100 is an inkjet recording device including a serial type recording head, in which a carriage 101 including a recording head 102 reciprocates to perform recording along the X-axis direction, which is perpendicular to the Y-axis direction. The recording method is not limited thereto. For example, the ink jet recording device may include a line type recording head in which a nozzle line is arranged over the recording width in the Y-axis direction. In addition to a device simply having a recording function, a multifunctional peripheral (MFP) may be used, in which a scan function, a fax function, a transmission function, and the like are integrated. An electrophotographic recording device using powder toner instead of liquid ink may be used.

The input/output unit 109 is provided on the recording unit 100. The input/output unit 109 is an operation panel, and displays, on a display, the remaining amount of ink and candidates for the type of recording medium. A user can select a type of a recording medium and/or perform setting of recording by operating a key of the input/output unit 109.

The carriage 101 includes the recording head 102 including nozzles that discharge the ink supplied from an ink tank 111 on a surface facing the conveyance path P of the recording medium. The carriage 101 is configured to reciprocate, by motor drive, in the X-axis direction (carriage moving direction) along a shaft 104 using a carriage belt 103.

The embodiment assumes that a paper sheet 105 is used as the recording medium, where the paper sheet 105 is roll paper, a cut sheet, or the like. As indicated above, the recording medium is not limited to paper. The paper sheet 105 is conveyed over the platen 106 in the Y-axis direction by the conveyance rollers 205 and 206. In a case of roll paper, when a plurality of jobs are printed, the plurality of jobs are continuously printed on paper, and accordingly, printing and drying are continuously repeated. In a case of a cut sheet, one job of printing is performed per one cut sheet, and accordingly, printing and drying are each performed once.

The carriage 101 causes the recording head 102 to move in the X-axis direction above the paper sheet 105 conveyed over the platen 106 by the conveyance rollers 205 and 206. The recording head 102 discharges ink droplets while moving to perform a recording operation. When the carriage 101 moves to an end of the recorded area on the paper sheet 105, the conveyance rollers 205 and 206 convey the paper sheet 105 in the conveyance direction (i.e., direction perpendicular to the reciprocating direction) by a certain amount to move the area where the next recording scanning is to be performed to a position where the recording head 102 can perform recording. Repeating the above operation causes an image to be recorded.

In the embodiment, a latex recording device that records an image with latex ink is used as the recording unit 100. An inkjet recording device using a typical aqueous ink requires an ink receiving layer on the recording medium for catching ink and preventing smearing. In contrast, in the case of a latex recording device, applying heat to the latex ink causes moisture to be evaporated, which causes the latex resin to be melted to mix with the pigment, thereby causing a film to be formed on the paper surface, and thus cured. The latex recording device can record an image even on a recording medium with no ink receiving layer.

In the embodiment, the recording medium on which an image has been recorded is conveyed to the fixing device 108. When heat is applied to the recording medium in the fixing device 108, the ink is cured and changes to a fixed state (i.e., finished state), and the recording medium is then ejected from the fixing device 108. After the recording medium is ejected from the fixing device 108, a cutting process is performed by a cutter 112 as necessary.

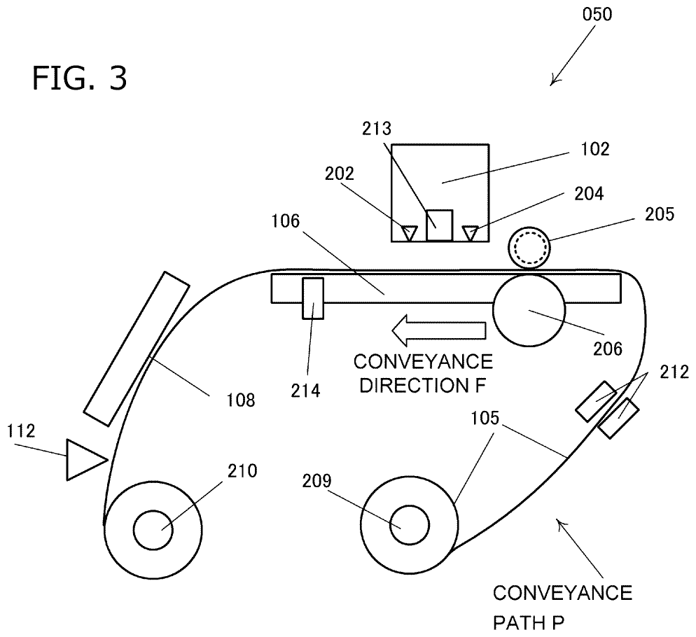

FIG. 3 is a schematic cross-sectional view illustrating a configuration for conveying the recording medium. The paper sheet 105 wound in a roll shape as the recording medium is loaded in a paper feeder 209 of the printing device 050. The paper sheet 105 fed from the paper feeder 209 is vertically sandwiched between the conveyance rollers 205 and 206, and is conveyed in the conveyance direction F as the conveyance rollers 205 and 206 rotate.

The encoder sensor 215 is attached to sandwich the conveyance roller 205 disposed on the upper side of the paper sheet 105. The encoder sensor 215 can be a general encoder that measures the conveyance amount of the paper based on the rotation speed of the roller.

At the time of measurement of the conveyance amount by the encoder sensor 215, there is a possibility that the conveyance roller 205 rotates freely, depending on the weight and surface characteristics of the paper sheet 105 loaded, thereby preventing the encoder sensor 215 from accurately measuring the conveyance amount. To prevent this, the user may perform band adjustment using the input/output unit 109. The band adjustment can be performed in “automatic” mode and “manual” mode.

In the “automatic” mode, a specific pattern is recorded in the main scanning direction (i.e., direction perpendicular to the conveying direction of the recording medium), the density of the specific pattern is read a plurality of times by the multi-sensor, and the conveyance amount is corrected based on a density difference obtained in that process. In the “manual” mode, the conveyance amount is corrected by recording graduations at intervals of inches or centimeters and manually inputting, to the input/output unit 109, the proportion of the correction amount determined by visual determination of the user. This enables the accuracy of the conveyance amount measurement to be maintained.

The paper type identification sensor 212 is mounted near the conveyance roller 206. The paper type identification sensor 212 estimates the type of the paper sheet 105 by detecting at least one of the surface characteristics or the basis weight of the paper sheet 105.

In the embodiment, the side closer to the paper feeder 209 of the conveyance path P is referred to as an upstream side, and the side closer to a winding unit 210 of the conveyance path P is referred to as a downstream side. The paper sheet 105 is supported from below by the platen 106, and the optical sensor 214 is mounted near the platen 106.

In the embodiment, an optical sensor such as one installed on a mouse for a PC is used as the optical sensor 214. The optical sensor 214 includes a radiation unit that emits light such as infrared radiation and a light receiving unit that receives reflected light from the surface of the paper sheet 105, and detects a change in surface characteristics caused by conveyance of the paper sheet 105 to calculate the conveyance amount. In general, the optical sensor 214 calculates the conveyance amount with higher accuracy than accuracy provided by the encoder sensor 215.

The optical sensor 214 is not limited to the above-described configuration. For example, as the optical sensor 214, a complementary metal oxide semiconductor (CMOS) image sensor can be adopted that detects a displacement amount needed for conveyance of the paper based on a front surface image acquired by imaging the front surface of the paper.

As described above, the recording head 102 that performs recording by ejecting ink from a nozzle is mounted on the carriage 101 of the recording unit 100. Among the nozzles of the recording head 102, the nozzle disposed at the most upstream position is referred to as a most upstream nozzle 204, and the nozzle disposed at the most downstream position is referred to as a most downstream nozzle 202. The multi-sensor 213 is typically mounted on the carriage 101. The multi-sensor 213 estimates the paper type from the thickness of the paper sheet 105 and/or the illuminance of the reflected light from the paper sheet 105.

The paper sheet 105 on which an image has been recorded by the recording head 102 is conveyed in the conveyance direction F and arrives at the fixing device 108. The fixing device 108 fixes the ink on the paper using heat. The paper sheet 105 is then conveyed and wound around the winding unit 210. In a case where the paper needs to be cut, the cutter 112 performs the cutting process.

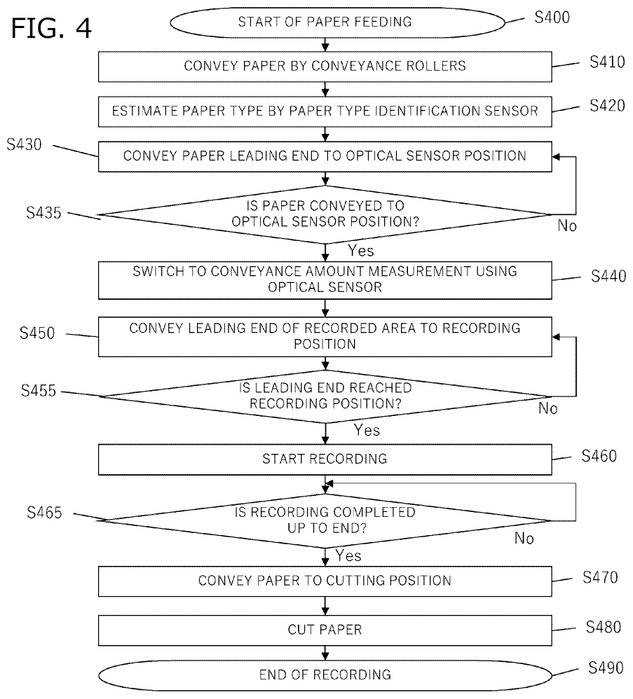

FIG. 4 is a flowchart illustrating an example of a basic operation of the embodiment, and illustrates a basic flow from the start of paper feeding to the end of printing. This flow is started by a user's print start instruction. Each step of the flow is executed by operation of each corresponding component of the printing device 050 under the control of the CPU 005. First, in step S400, the paper sheet 105 in a roll form is unwound from the paper feeder 209, and paper feeding is started. Next, in step S410, the paper sheet 105 is conveyed by the conveyance rollers 205 and 206.

In step S420, the paper type identification sensor 212 estimates the type of the paper sheet 105. Then, in step S430, the conveyance rollers 205 and 206 convey the leading end of the paper sheet 105 toward the position of the optical sensor 214. While the conveyance rollers 205 and 206 are driven, the CPU 005 can measure the conveyance amount based on an output signal of the encoder sensor 215.

Next, in step S435, the CPU 005 determines whether the leading end of the paper sheet 105 has reached the position of the optical sensor 214 based on the output signal of the optical sensor 214. In a case where the leading end of the paper sheet 105 has reached the position of the optical sensor 214 (S435=Yes), the process proceeds to step S440, and the CPU 005 switches the conveyance amount measurement method from using the encoder sensor 215 to using the optical sensor 214. The conveyance amount from the start of paper feeding can be calculated without a blank period by calculating the conveyance amount until the paper sheet 105 reaches the optical sensor 214 based on the output of the encoder sensor 215, and calculating the conveyance amount after reaching the optical sensor 214 based on the output of the optical sensor 214. In a case where the paper sheet 105 has not reached the position of the optical sensor 214 (S435=No), step S430 is repeated.

In step S450, the conveyance rollers 205 and 206 convey the recorded area of the paper sheet 105 to the recording position immediately below the recording head of the recording unit 100. The recorded area may be a leading end area of the paper sheet 105 in the conveyance direction, or may be an area distant from the leading end of the paper by a length that has been set.

Next, in step S455, the CPU 005 determines, based on the conveyance amount, whether the leading end of the recorded area has been conveyed to the recording position. In a case where the leading end of the recorded area has reached the recording position (S455=Yes), the process proceeds to step S460, and the recording head 102 starts image recording. In a case where the leading end of the recorded area has not reached the recording position (S455=No), step S450 is repeated.

In the control of conveying the paper sheet 105 during image recording, the CPU 005 specifies the conveyance amount each time the recording head 102 mounted on the carriage 101 makes one reciprocation. Then, while the measurement is continued using the encoder sensor 215 or the optical sensor 214, the paper is conveyed by the conveyance rollers 205 and 206 by the specified conveyance amount.

In step S465, the CPU 005 determines whether recording has been completed up to the end of the recorded area. When the recording has been completed (S465=Yes), the process proceeds to step S470. When the recording has not been completed (S465=No), the recording continues. In step S470, the conveyance rollers 205 and 206 convey the paper sheet 105 to a cutting position. Next, in step S480, the cutter 112 cuts the paper sheet 105. Recording is then completed at step S490.

In a case where the product of image recording is wound by the winding unit 210 or in a case where the user manually performs cutting, steps S470 to S480 may be skipped.

A basic conveyance amount measurement method according to the embodiment has been described above with reference to FIG. 4. According to this method, the measurement is performed by the encoder sensor 215 until the paper sheet 105 reaches the area where the optical sensor 214 can be used. Thus, the conveyance amount can be measured without a blank period by performing highly accurate measurement by the optical sensor 214 in the area where the optical sensor 214 can be used, and also using the encoder sensor 215 in combination. As described above, there is a possibility that the optical sensor 214 undergoes a decrease in the accuracy thereof or fails to perform measurement depending on the type of the recording medium. The following description discusses a conveyance amount measurement method adapted to various recording media using a plurality of examples.

### EXAMPLE 1

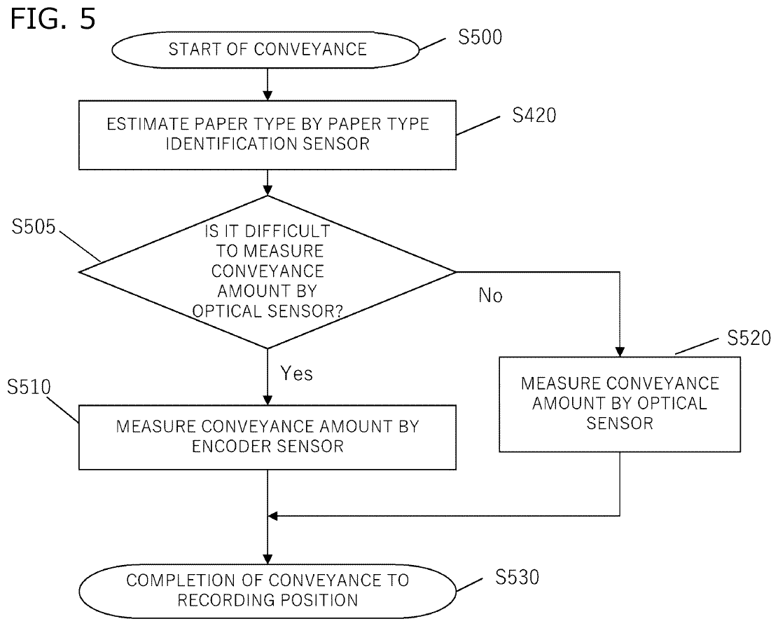

FIG. 5 is a flowchart illustrating a paper conveyance operation according to Example 1. The optical sensor 214 is used as the main device for measuring the conveyance amount of the paper sheet 105 since it is generally considered to have high accuracy. The conveyance amount is typically measured at the time of feeding the paper sheet 105 to the recording unit 100 or at the time of performing a recording operation. Example 1 will describe a case where the conveyance amount is measured at the time of feeding paper. In FIG. 4, the devices are switched from the encoder sensor 215 to the optical sensor 214 in this order as the conveyance proceeds. In Example 1, the measurement is performed in a partially different flow.

In step S500, the conveyance rollers 205 and 206 rotate to start conveyance of the paper sheet 105. This step corresponds to step S410 in FIG. 4. Next, in step S420, the paper type is estimated by the paper type identification sensor 212 similar to the process of FIG. 4.

In step S505, the CPU 005 determines whether the paper sheet 105 is of a type that causes difficulty in measuring the conveyance amount by the optical sensor 214 based on the estimation result of the paper type. For example, in a case where the type of the recording medium is a recording medium that easily transmits light (i.e., recording medium having a light transmittance greater than or equal to a predetermined value) such as a film, measurement by the optical sensor 214 is difficult.

Instead of using a result of estimation performed by the paper type identification sensor 212, determining whether measurement of the conveyance amount by the optical sensor 214 is difficult may be performed based on a measurement result of the optical sensor 214 itself. For example, in a case where a certain number or more of feature amounts of the paper sheet surface cannot be read by the optical sensor 214, it can be determined that the measurement is difficult.

When the measurement is difficult (S505=Yes), the process proceeds to step S510. When the recording medium is not of a type that causes difficulty in measuring the conveyance amount, such as plain paper or glossy paper (S505=No), the process proceeds to step S520. The predetermined value of the transmittance serving as a reference of the light transmittance of the recording medium may be determined based on the performance of the optical sensor 214 or a desirable level for recording control.

The type of the recording medium for which the optical sensor 214 is used for measurement is herein referred to as first type, and the type of the recording medium for which the encoder sensor 215 is used for measurement is herein referred to as second type, which is different from the first type. That is, Example 1 uses different measurement methods when two different types of recording media are used. A typical first type of recording medium is plain paper, but may also include glossy paper, thick paper, and cloth. A typical second type of recording medium is a film. Classifications other than the first type and the second type may be used. For example, classification may be performed in such a manner that glossy paper is a third type of recording medium, thick paper is a fourth type of recording medium, and cloth is a fifth type of recording medium, where measurement methods

In step S510, the CPU 005 measures the conveyance amount using the encoder sensor 215. In step S520, the CPU 005 performs setting to measure the conveyance amount using the optical sensor 214. As in the case of FIG. 4, the measurement value obtained by the encoder sensor 215 is used until the paper sheet 105 reaches the optical sensor 214, and the measurement value of the optical sensor 214 is used after the paper sheet reaches the optical sensor 214, whereby measurement can be performed without a blank period. When the same type of sheet is set thereafter, the conveyance amount estimation method adopted in the corresponding operation may be adopted. The process then proceeds to step S530, and the conveyance of the paper sheet 105 to the recording position is completed, and image recording and post-processing are performed as illustrated in FIG. 4.

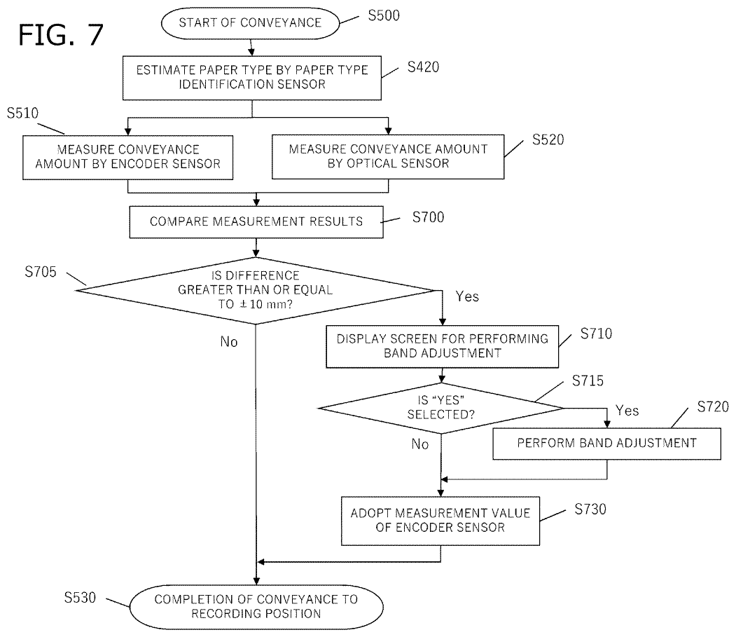

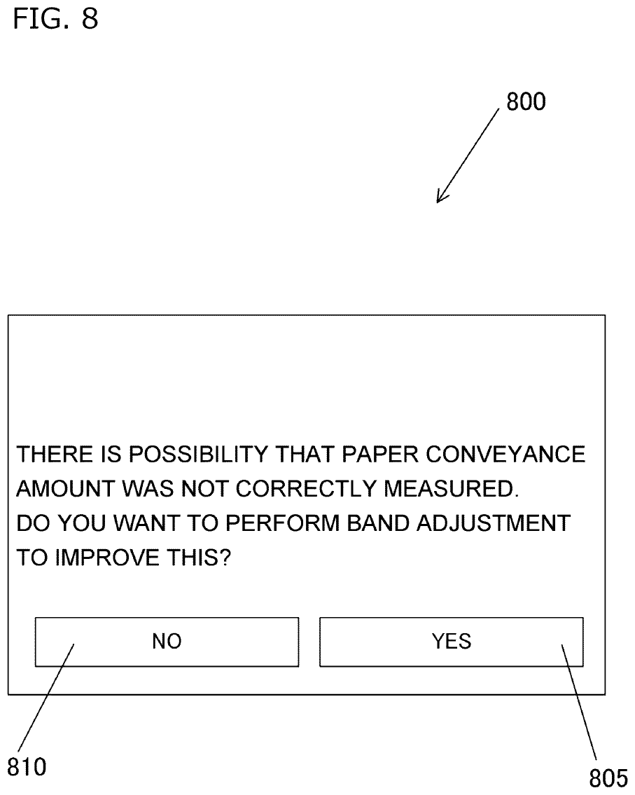

Even when the determination at step S505 causes conveyance amount measurement to be performed by the encoder sensor 215 (i.e., even when the process proceeds to step S510), measurement of the conveyance amount by the optical sensor 214 may be continued. Then, in a case where the difference between the measurement results of the optical sensor 214 and of the encoder sensor 215 is greater than or equal to a predetermined range (e.g., ±10 mm), the user may be prompted to perform band adjustment. FIG. 7, described below, illustrates a flowchart of this process, and FIG. 8 illustrates an example of a display screen for prompting the user to perform band adjustment.

The paper type determination method is not limited to use of the paper type identification sensor 212. For example, the user may input the type of the loaded recording medium using the input/output unit 109. When the user inputs information indicating that the paper type is a film, the CPU 005 adopts the measurement value of the encoder sensor 215.

The processing may be performed such that the CPU 005 adopts the estimation result of the paper type identification sensor 212 only when there is no input setting by the user. The CPU 005 using information set by the user may determine whether the estimation result from the paper type identification sensor 212 matches the information that has been set by the user, and may notify the user when the estimation result does not match the information that has been set by the user.

The paper type information may be stored in an identification medium in association with the recording medium and read by the printing device 050. The identification medium may be, for example, an integrated circuit (IC) tag or a barcode provided on the core of the roll paper.

According to Example 1, it is determined whether the optical sensor 214 is suitable for that recording medium. When the optical sensor 214 is suitable, highly accurate measurement is performed using the optical sensor 214. When the optical sensor is unsuitable, measurement is reliably performed using the encoder sensor 215. This enables the accuracy to be increased as high as possible while increasing the availability of the conveyance amount measurement.

### EXAMPLE 2

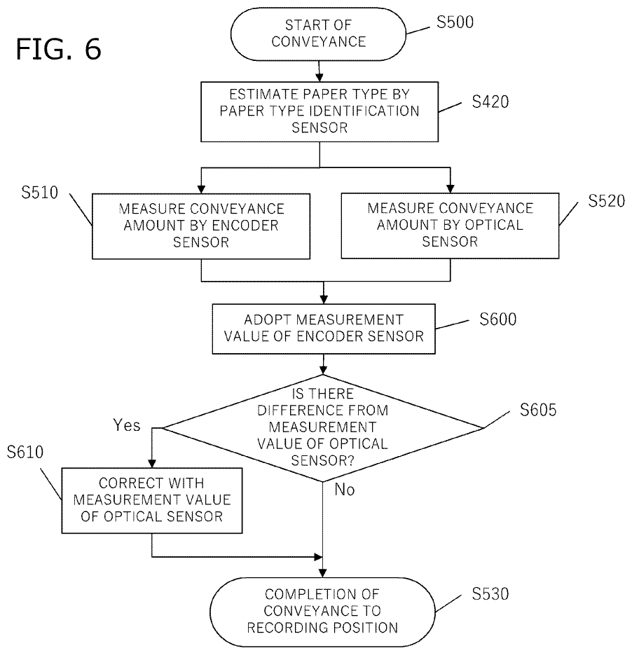

FIG. 6 is a flowchart illustrating a paper conveyance operation according to Example 2. In Example 2, the encoder sensor 215 is used as a main device for measuring the conveyance amount. The optical sensor 214 is used to correct the measurement value. The description of Example 2 describes a paper conveyance operation in the paper feeding operation as an example similar to Example 1.

In steps S500 to S420, the processing proceeds similar to Example 1 (FIG. 5). In Example 2, the measurement by the encoder sensor 215 at step S510 and the measurement by the optical sensor 214 at step S520 are performed in parallel.

The process then proceeds to step S600, in which the CPU 005 adopts the measurement value of the encoder sensor 215 as the conveyance amount. In step S605, the CPU 005 determines whether there is a difference between the measurement value of the encoder sensor 215 and the measurement value of the optical sensor 214. The CPU 005 may determine whether the difference between the measurement values falls within a predetermined range. In a case where there is a difference greater than or equal to the predetermined range (S605=Yes), the process proceeds to step S610. In step S610, the CPU 005 corrects the measurement value of the encoder sensor 215 with the measurement value of the optical sensor 214. The process then proceeds to step S530, and the conveyance of the paper to the recording position is completed. When there is no difference between the measurement values (S605=No), the process is completed.

FIG. 7 is a flowchart illustrating a variation of Example 2. Steps S500 to S520 are similar to the flow of FIG. 6. In step S700, the CPU 005 compares the measurement results of the optical sensor 214 and of the encoder sensor 215. Next, in step S705, the CPU 005 determines whether the comparison result is greater than or equal to a predetermined value (e.g., ±10 mm). In a case where the comparison result is greater than or equal to the predetermined value (S705=Yes), the process proceeds to step S710, in which the CPU 005 prompts the user to perform band adjustment. When the comparison result is less than the predetermined value (S705=No), the process proceeds to step S530 to complete the process.

FIG. 8 is an example of a screen displayed on the input/output unit 109 to prompt band adjustment. A window 800 displays a message prompting band adjustment, a “Yes” button 805, and a “No” button 810. When the user selects the “Yes” button 805 (S715=Yes), the CPU 005 performs band adjustment.

When the user selects the “No” button 810 (S715=No), the process proceeds to step S730, in which the result of measuring the conveyance amount by the encoder sensor 215 is adopted without performing adjustment. The process then proceeds to step S530, and the conveyance is completed.

Even when the conveyance amount measurement by the encoder sensor 215 has been adopted in step S510, the band adjustment may be performed each time the winding diameter of the paper sheet 105 decreases by a certain amount when paper of a paper type has been loaded that causes difficulty in correcting the conveyance amount by band adjustment. The paper type that causes difficulty in correcting the conveyance amount by the band adjustment may be determined from the size, weight, and surface characteristics of the paper. The paper type that causes difficulty in measurement of the conveyance amount by the optical sensor 214 and/or in correcting the conveyance amount by band adjustment may be stored in advance in the NVRAM 008. As described above, both manual and automatic band adjustment can be adopted. Instead of a message prompting the band adjustment, or together with a message prompting the band adjustment, a message prompting the user to confirm the state of the paper sheet 105 may be displayed.

As described above, when the paper type is a film or the like, there is a case where accuracy is deteriorated or measurement is difficult despite the optical sensor 214 performing highly accurate measurement when the conveyance amount of the paper sheet 105 is to be measured. Therefore, in the present disclosure, it is estimated whether the paper sheet 105 is of a paper type that causes difficulty in measuring the conveyance amount by the optical sensor 214 based on the identification result of the paper type identification sensor 212 or the information that has been set by the user. When it is determined that the measurement is difficult, the measurement method is switched to the measurement of the conveyance amount by the encoder sensor 215. This enables the conveyance amount to be measured regardless of the paper type. As a result, the printing device accurately measures the conveyance amount based on the type of the recording medium.

According to the present disclosure, the printing device can accurately measure the conveyance amount based on the type of the recording medium.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-009187, filed Jan. 22, 2025, which is hereby incorporated by reference herein in its entirety.

What is claimed is:

1. A printing device comprising:
a conveyance unit that conveys a recording medium along a conveyance path;
a first measurement unit provided on the conveyance path that measures a conveyance amount of the recording medium based on light reflected from the recording medium;
a second measurement unit that measures the conveyance amount of the recording medium based on an amount of driving of the conveyance unit;
a recording unit that records an image on the recording medium; and
a control unit that performs control of recording performed by the recording unit based on a measurement result of the first measurement unit in a case where the recording medium is a first type and performs control of recording performed by the recording unit based on a measurement result of the second measurement unit in a case where the recording medium is a second type, wherein the second type is different from the first type.

2. The printing device according to claim 1, wherein the first measurement unit is an optical sensor comprising a radiation unit and a light receiving unit, wherein the radiation unit emits light to the recording medium and the light receiving unit receives the light reflected from the recording medium.

3. The printing device according to claim 1, wherein the first measurement unit measures the conveyance amount by acquiring a surface image of the recording medium.

4. The printing device according to claim 1, wherein the second measurement unit is an encoder sensor provided on a conveyance roller included in the conveyance unit.

5. The printing device according to claim 2, wherein the second measurement unit is an encoder sensor provided on a conveyance roller included in the conveyance unit.

6. The printing device according to claim 3, wherein the second measurement unit is an encoder sensor provided on a conveyance roller included in the conveyance unit.

7. The printing device according to claim 1, wherein the control unit performs the control based on the measurement result of the second measurement unit in a case where the recording medium has a light transmittance greater than or equal to a predetermined value.

8. The printing device according to claim 1, wherein the control unit performs the control based on the measurement result of the second measurement unit in a case where the recording medium is a film.

9. The printing device according to claim 1, further comprising an identification unit provided on the conveyance path and identifies a type of the recording medium.

10. The printing device according to claim 2, further comprising an identification unit that is provided on the conveyance path and identifies a type of the recording medium.

11. The printing device according to claim 3, further comprising an identification unit that is provided on the conveyance path and identifies a type of the recording medium.

12. The printing device according to claim 9, wherein the identification unit performs identification by detecting at least one of surface characteristics or a basis weight of the recording medium.

13. The printing device according to claim 9, wherein the identification unit performs identification by reading an identification medium provided on the recording medium.

14. The printing device according to claim 1, further comprising an input unit that receives an input from a user, wherein the control unit determines a type of the recording medium based on the received input.

15. The printing device according to claim 1, wherein the first measurement unit is disposed on a downstream side of the second measurement unit on the conveyance path, and wherein the control unit performs control using a measurement value of the second measurement unit at least until the recording medium reaches the first measurement unit.

16. The printing device according to claim 1, wherein the control unit performs correction to the measurement result of the second measurement unit using the measurement result of the first measurement unit.

17. The printing device according to claim 16, wherein the control unit performs the correction in a case where the measurement result of the second measurement unit differs from the measurement result of the first measurement unit by an amount greater than or equal to a predetermined range.

18. The printing device according to claim 16, further comprising an output unit that outputs information to a user, wherein in a case where the measurement result of the second measurement unit differs from the measurement result of the first measurement unit by an amount greater than or equal to a predetermined range, the control unit outputs, to the output unit, a message prompting the user to make a correction.

19. The printing device according to claim 1, wherein the recording medium is wound in a roll shape.

20. A method for controlling a printing device, the method comprising:
conveying a recording medium along a conveyance path using a conveyance unit;
a first measuring that measures a conveyance amount of the recording medium based on light reflected from the recording medium;
a second measuring that measures the conveyance amount of the recording medium based on an amount of driving of the conveyance unit;
recording an image on the recording medium; and
performing control of the recording based on a measurement result of the first measuring in a case where the recording medium is a first type and performing control of the recording based on a measurement result of the second measuring in a case where the recording medium is a second type, wherein the second type is different from the first type.
